(19) United States
(12) Patent Application Publication
(10) Pub. No.: US 2023/0295011 A1
(43) Pub. Date: Sep. 21, 2023

(54) Injection of Off-Gas from Sour Water Stripper

(71) Applicant: Saudi Arabian Oil Company, Dhahran (SA)

(72) Inventors: Abdullah M. Abdulrahman, Al Khobar (SA); Ahmed Al Seoud, Dhahran (SA)

(21) Appl. No.: 17/700,042

(22) Filed: Mar. 21, 2022

(51) Int. Cl. C02F 1/20; E21B 43/16; F23G 7/08

(52) U.S. Cl. CPC C02F 1/20; E21B 43/168; F23G 7/08; C02F 2101/101

(57) ABSTRACT

A system and method for treating sour water, including flowing sour water and a stripping agent in a countercurrent flow with respect to each other in a sour water stripper column to remove hydrogen sulfide from the sour water into the stripping agent to give treated water, discharging the spent stripping agent (having the hydrogen sulfide) from the sour water stripper column through an ejector to an injection compressor, and injecting the spent stripping agent into a hydrocarbon reservoir.

### TECHNICAL FIELD

This disclosure relates to processing of sour water in a sour water stripper and the disposition of hydrogen sulfide that discharges from the stripper.

### BACKGROUND

Sour water may be water (e.g., produced formation water, aquifer water, wellhead water, process water, refinery water, wastewater, etc.) that has hydrogen sulfide (H₂S), e.g., at least at trace levels or at least 20 part per million (ppm) by weight of H₂S. The sour water may additionally include ammonia (NH₃) in some cases. Sources of sour water can vary. Sour water may be generated, for example, in petroleum refineries or gas processing plants. For instance, sour water can include wastewater produced from atmospheric and vacuum crude columns in refineries. Sour water may be water (produced water) produced from a subterranean formation. The sour water can be water produced along with hydrocarbon (e.g., crude oil and/or natural gas). The sour water can be water produced from an aquifer in a subterranean formation with little or no hydrocarbon. To remove H₂S (and NH₃) from sour water to recover the water for reuse, the sour water may be subjected to stripping (via a stripping agent) in a sour water stripper to remove the H₂S. The sour water stripper is a vessel that is a stripping tower or column. The stripped hydrogen sulfide (and/or stripped ammonia if present) discharges overhead from the column. The removed H₂S may be recovered at some facilities. The recovered water discharges as a bottoms stream from the stripper column.

### SUMMARY

An aspect relates to a method of treating sour water, including flowing sour water and a stripping agent in a countercurrent flow with respect to each other in a sour water stripper column, and removing hydrogen sulfide from the sour water in the sour water stripper column to give treated water, wherein removing the hydrogen sulfide from the sour water involves transfer of hydrogen sulfide from the sour water to the stripping agent. The method includes discharging off-gas from the sour water stripper column through an ejector to an injection compressor, the off-gas including the stripping agent and the hydrogen sulfide removed from the sour water. The method includes increasing, via the ejector, pressure of the off-gas. The method includes injecting, via the injection compressor, the off-gas into a hydrocarbon reservoir in a subterranean formation.

Another aspect relates to a method of treating sour water, including feeding sour water to an upper portion of a sour water stripper column and flowing the sour water downward in the sour water stripper column, feeding a stripping agent to a lower portion of the sour water stripper column and flowing the stripping agent upward in the sour water stripper column in a countercurrent flow direction with respect to the sour water, and stripping hydrogen sulfide from the sour water via the stripping agent to give treated water. The method includes discharging off-gas overhead from the upper portion of the sour water stripper column to an ejector that provides motive force for flow of the off-gas to an injection compressor, wherein the off-gas includes the stripping agent and the hydrogen sulfide stripped from the sour water. The method includes providing motive gas to the ejector. The method includes injecting, via the injection compressor, the off-gas into a hydrocarbon reservoir in a subterranean formation.

Yet another aspect relates to a sour water stripper system including a sour water stripper column that is a stripper column vessel to receive sour water and a stripping agent to strip hydrogen sulfide from the sour water via the stripping agent in a countercurrent flow of the sour water with the stripping agent to give treated water and off-gas. The sour water stripper system includes an ejector to receive the off-gas discharged from the stripper column vessel and discharge the off-gas via a motive gas to an injection compressor for injection of the off-gas into a hydrocarbon reservoir. The sour water stripper system includes an off-gas discharge conduit to convey the off-gas from the stripper column vessel to the ejector, and an ejector discharge conduit to convey the off-gas and the motive gas from the ejector to a suction of the injection compressor.

Yet another aspect relates sour water stripper system including a sour water stripper column that includes a stripper column vessel having internals to strip hydrogen sulfide from sour water via a stripping agent in a countercurrent flow of the sour water with the stripping agent to give treated sour water and off-gas, wherein the treated sour water includes the sour water minus the hydrogen sulfide stripped from the sour water, and wherein the off-gas includes the stripping agent and the hydrogen sulfide stripped from the sour water. The sour water stripper system includes a sour-water feed conduit to convey the sour water from a source to a sour-water feed inlet on an upper portion of the stripper column vessel for flow of the sour water downward in the stripper column vessel. The sour water stripper system includes a stripping-agent feed conduit to convey the stripping agent to a stripping-agent feed inlet on a lower portion of the stripper column vessel for flow of the stripping agent upward in the stripper column vessel. The sour water stripper system includes an ejector to provide motive force for flow of the off-gas to an injection compressor for injection of the off-gas by the injection compressor into a hydrocarbon reservoir, wherein the ejector is configured to receive the off-gas discharged from the stripper column vessel through an off-gas outlet on a top portion of the stripper column vessel.

The details of one or more implementations are set forth in the accompanying drawings and the description below. Other features and advantages will be apparent from the description and drawings, and from the claims.

### BRIEF DESCRIPTION OF DRAWINGS

FIG. 1 is a diagram of a sour water stripper system having a sour water stripper column and an off-gas ejector.

FIG. 2 is a block flow diagram of method of treating sour water, such as with a sour water stripper system (e.g., the sour water stripper system of FIG. 1).

FIG. 3 is a block flow diagram of a method of retrofitting a sour water stripper system that flares off-gas.

### DETAILED DESCRIPTION

Some aspects of the present disclosure are directed to flowing a stripping agent (e.g., nitrogen, air, natural gas, etc.) countercurrent to flow of sour water through a stripper column, thereby removing (stripping by mass transfer) H₂S from the sour water to the stripping agent. The stripping agent as spent (having the removed H₂S) is discharged from the stripper column through a motive device (utilizing motive gas) to the suction of an injection compressor for injection of the spent stripping agent (and the motive gas) into a hydrocarbon reservoir (e.g., for pressure maintenance of the hydrocarbon reservoir). The motive device (e.g., an ejector utilizing the motive gas) increases the pressure of the spent stripping agent (which may be labeled as off-gas or acid gas) discharged from the stripper column to accommodate the suction pressure of the injection compressor.

In implementations, the sour water, e.g., having at least 50 part per million (ppm) by weight of H₂S, to be treated may be from oil and/or gas wells, or from water supply wells. In certain implementations, the sour water may generally discharge from a wellhead to the sour water stripper column. The sour water may enter the sour water stripper package that reduces H₂S content of the sour water utilizing the stripping agent. In implementations, a strong mineral acid (e.g., sulfuric acid) may be added to the sour water prior to introduction of the sour water into the sour water stripper column to increase effectiveness of separation of hydrogen sulfide from the sour water in the stripper column. The sour water with the added acid can be labeled as acidified sour water or raw water.

Embodiments include a retrofit of an existing sour water stripper system. The existing sour water stripper system is configured to discharge the spent stripping agent (e.g., having at least 20,000 ppm by weight of hydrogen sulfide) from the sour water stripper column to a flare. Again, this spent stripping agent can be labeled as acid gas (or off-gas). The retrofit can include installation of the ejector to route the acid gas (off-gas) from the sour water stripper column to the injection compressor instead of to the flare. Therefore, these implementations can be characterize as off-gas compression to cease acid gas flaring. This may beneficially reduce plant flaring and emissions. The retrofit can include capability to provide the off-gas (acid gas) from the stripper column to the flare, such as might be beneficial when the injection compressor is temporarily shut down (e.g., via a machine trip) or otherwise operationally unavailable.

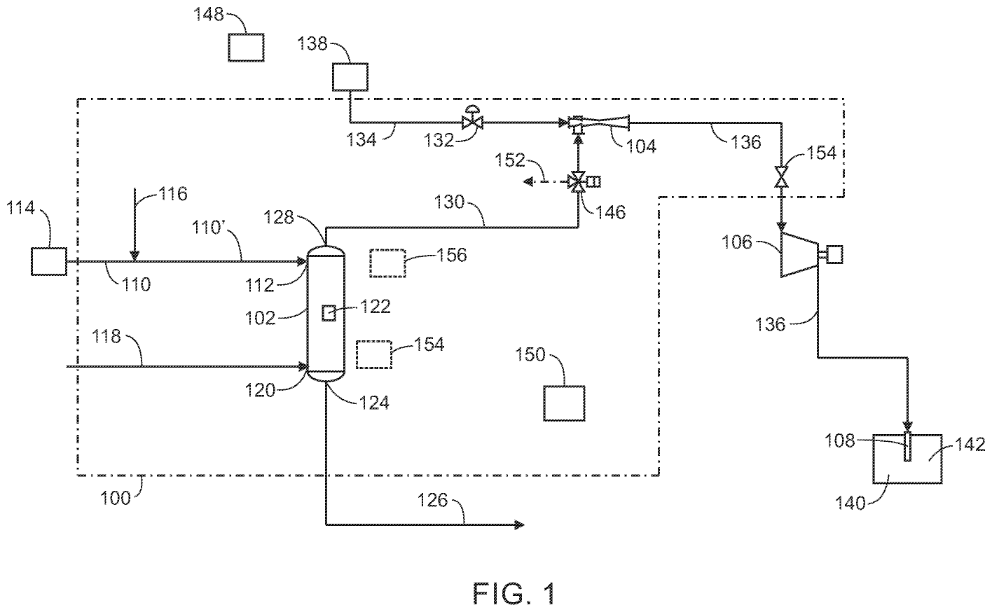

The off-gas (the stripping agent having the stripped hydrogen sulfide) when routed to the flare can lead to undesirable emissions (e.g., SOx and NOx) at the flare. Embodiments herein advantageously utilize this off-gas stream, not as a waste to be flared (combusted), but instead as a valuable stream to be routed to injection-well compressors to increase and maintain pressure of the oil reservoir. As indicated, this can be achieved through utilizing the ejector equipment to raise the pressure of the off-gas stream via a motive gas to meet the suction pressure of the injection compressor, as indicated in FIGS. 1-3.

The motive gas supplied to the ejector may be a slipstream from a hydrocarbon gas stream available at the facility and having adequate pressure to suck (draw in) and compress (increase pressure of) the off-gas stream to at least the suction pressure of the injection compressor. Moreover, a control valve may be installed along the motive-gas supply conduit to control flow of the motive gas to the ejector. A diversion control valve may be installed along the off-gas conduit to divert the sour water stripper off-gas (e.g., during a machine trip of the injection compressor), such as to route the sour water stripper off-gas to the flare.

Thus, a grassroots installation or a retrofit may involve installing ejector equipment to raise the pressure of acid gas (off-gas) via utilizing motive gas (e.g., fuel gas or a slipstream of a hydrocarbon process stream). Again, a control valve may be installed to control the flow of the motive gas to the ejector. A control valve (e.g., 3-way valve) may be installed to control flow of the off-gas including in certain implementations to divert the off-gas to the flare in response to a shutdown (e.g., machine trip) of the injection compressor

Simulation software was utilized in the Example below to simulate a sour water stripper system as generally depicted in FIG. 1. In the simulation, a basis was the sour water (e.g., coming from water wells) has 200 ppm by weight of H₂S and enters the sour water stripper column at an upper or top portion. In the simulation, nitrogen gas enters the column as stripping agent at a lower or bottom portion of the stripper column to flow upward in the column to strip H₂S from the sour water. The nitrogen gas as stripping agent carries out the stripped H₂S by being discharged from the top portion of the column. This stream may be labeled as off-gas (characterized as acid gas because of relatively high H₂S content) and is routed to ejector to raise the pressure utilizing fuel gas as a motive gas. Then, the off-gas as pressurized is routed from the ejector to the suction of the injection compression unit to inject the off-gas into an oil reservoir (crude oil).

FIG. 1 is a sour water stripper system 100 including a sour water stripper column 102 and an ejector 104 (e.g., an off-gas ejector). The sour water stripper system 100 can be characterized as a system for treating sour water, and for providing off-gas (including hydrogen sulfide stripped from the sour water) to the injection compressor 106 for injection. The injection compressor 106 can be a component of the sour water stripper system 100 and/or a component of a downstream injection system at an injection well 108. The injection compressor 106 may be an injection-well compressor. The injection compressor can be one of several injection compressors at the injection well.

The sour water stripper column 102 may be a stripper column vessel having internals (e.g., trays, packing, etc.) to strip hydrogen sulfide from sour water via a stripping agent in a countercurrent flow of the sour water with the stripping agent to give treated sour water (which may be labeled as treated water) and off-gas. The treated sour water may include the sour water minus the hydrogen sulfide (and minus any other components) stripped from the sour water. The treated sour water may no longer be sour. The off-gas may include the stripping agent and the hydrogen sulfide (and any other components) stripped from the sour water.

The term “sour water stripper” is known by one of ordinary skill in the art, and may be called a sour water stripper column (which may also be labeled as a sour water stripper tower). The column is a vessel. The vessel is typically a cylindrical vessel with a vertical orientation and having elliptical or semi-elliptical heads. Thus, the sour water stripper column 102 is a vertical column as a vessel having a vertical orientation. The length/diameter (L/D) ratio may be, for example, in a range of 5 to 15. The vessel diameter (nominal diameter or inside diameter) may be, for example, in the range of 1 foot to 6 feet. The vessel may be stainless steel, or carbon steel with stainless steel cladding, or other materials.

The vessel of the sour water stripper column 102 may be a pressure vessel. This column vessel may be a pressure vessel designed and configured (e.g., with adequate wall thickness) to be subjected to an internal pressure up to a specified pressure (design pressure) greater than ambient pressure (atmospheric pressure). A pressure vessel may be rated to hold a fluid up to the design pressure. In operation, the operating pressure in a pressure vessel may generally be maintained less than the design pressure. A pressure vessel may be constructed per a formal standard or code, such as the American Society of Mechanical Engineers (ASME) Boiler & Pressure Vessel Code (BPVC) or the European Union (EU) Pressure Equipment Directive (PED).

In operation, sour water 110 is provided (fed) to the sour water stripper column 102. The term “sour water” is known by one of ordinary skill in the art. In the illustrated embodiment, the sour water 110 is provided to a sour-water feed inlet 112 on an upper portion of the sour water stripper column 102, so that the sour water 110 may flow downward internally in the sour water stripper column 102. The sour water 110 may be provided to the sour water stripper column 102 from the source 114 of the sour water 110 via a sour-water feed conduit coupled to the sour-water feed inlet 112. The sour-water feed inlet 112 may be a vessel inlet nozzle to give a flanged connection, threaded (screwed) connection, or welded connection to the sour-water feed conduit.

The sour water 110 may have trace levels of hydrogen sulfide. However, in the presently disclosed context, the sour water 110 generally includes at least 20 part per million (ppm) by weight (ppmv) of hydrogen sulfide. The sour water 110 is water that has hydrogen sulfide, for example, in ranges of 20 ppmv to 20,000 ppmv, 50 ppmv to 10,000 ppmv, 75 ppmv to 5000 ppmv, or 100 ppmv to 2000 ppmv. The sour water 110 may additionally have ammonia, ammonium hydrosulfide, hydrosulfide ions, phenol, phenolic compounds, hydrogen cyanide, hydrocarbon, etc. The composition of the sour water 110 may generally depend on the source 114 of the sour water 110.

The source 114 of the sour water 110 may be a refinery, natural gas processing plant, a sulfur recovery unit (SRU) or Claus tail-gas treatment system, a wellhead at a well, or other sources. The sour water 110 may be generated, for example, in petroleum refineries or gas processing plants. For instance, the sour water 110 can include wastewater produced from atmospheric and vacuum crude columns in refineries. The sour water 110 may be water (produced water) produced from a subterranean formation and having hydrogen sulfide. The sour water 110 can be produced water separated from a mixture produced from via a wellbore from a subterranean formation, and with the mixture having the sour water and hydrocarbon. The sour water 110 can be water produced from aquifer in a subterranean formation produced via a wellbore of a water well.

For a wellhead at a well as the source 114, the sour water 110 may generally be produced water (having hydrogen sulfide) from the subterranean formation. This produced water is discharged (produced) from the subterranean formation via the wellhead as the sour water 110 to the sour water stripper column 102. In implementations, the produced water may be processed or treated at the wellhead prior to being sent as the sour water 110 to the sour water stripper column 102. In other implementations, little or no processing of the sour water 110 is implemented at the wellhead. Again, the source 114 may be a water supply well having a wellbore formed through the Earth surface into a subterranean formation having an aquifer, and in which water is produced from the aquifer through the wellbore the Earth surface. A wellhead at the surface at the water supply well may direct the produced water toward the sour water stripper column 102.

In certain implementations, a relatively small amount of acid 116 (e.g., a strong acid or mineral acid, such as sulfuric acid) may be added to the sour water 110. In those implementations, the reference numeral 110′ is utilized in FIG. 1 to indicate that the sour water 110 has been subjected to acidification to give sour water 110′ (which also can be labeled as raw water). The addition of the acid 116 reduces the pH of the sour water 110, such as from 7 to 2-3. This reduction in pH may increase effectiveness of separation of hydrogen sulfide from the sour water in the sour water stripper column 102. In particular, acidification with a mineral acid may “fix” NH₃ (if present) in salt to promote efficiency of removal of hydrogen sulfide in the stripper column. The addition of strong acid may liberate the hydrogen sulfide (and hydrogen cyanide and carbon dioxide if present) while keeping the ammonia as a salt in the sour water.

A mixer may be installed along the sour-water feed conduit to facilitate or promote mixing of the acid 116 with the sour water 110. For example, the mixer may be an in-line static mixer (the static mixer may be installed in-line in the sour-water feed conduit). In examples, the acid 116 may be added (e.g., via pipe tee) to the sour-water feed conduit upstream of the static mixer.

In operation, a stripping agent 118 is provided (fed) to the sour water stripper column 102. The stripping agent 118 (e.g., nitrogen) may be provided to a stripping-agent feed inlet 120 on the lower portion of the sour water stripper column 102, so that the stripping agent 118 may flow upward internally in the sour water stripper column 102. Thus, the stripping agent 118 may flow in the stripper column 102 in a countercurrent flow (direction) with respect to the sour water 110 flowing downward.

The stripping agent 118 may be a gas (e.g., nitrogen, air, noble gases, natural gas, fuel gas, methane, etc.). In implementations, the gas as stripping agent 118 (e.g., nitrogen, noble gases, etc.) is inert at the operating conditions of the sour water stripper column 102. In certain implementations, the stripping agent 118 is nitrogen (N₂) gas. The stripping agent 118 may be primarily nitrogen gas. In other words, the majority of the stripping agent 118 stream fed to the stripper column 102 may be nitrogen gas. In implementations, the stripping agent 118 may be at least 95 volume percent of nitrogen gas. In some implementations, nitrogen may be supplied as the stripping agent 118 from a nitrogen sub-header conduit (plant nitrogen) in the facility or from a tube bank trailer having compressed nitrogen, and so forth.

A stripping-agent feed conduit may convey the stripping agent 118 to the stripping-agent feed inlet 120. The stripping-agent feed conduit may be coupled to the source of the stripping agent 118. The stripping-agent feed inlet 120 may be a vessel inlet nozzle of the stripper column to give a connection with the stripping-agent feed conduit. The connection may be, for example, a flanged connection, a threaded (screwed) connection, or a welded connection.

The stripper column 102 may have internals 122, such as trays or packing, to promote or facilitate the removal or stripping of hydrogen sulfide from the sour water 110. A column having packing may be known as a packed column. A column having trays may be known as a trayed column or trayed tower. The trays may be, for example, sieve trays, valve trays, or bubble cap trays. The packing (if employed) may be random (dumped) packing or structured packing (e.g., in a fixed bed(s) of the packing). The packing (e.g., rings, saddles, etc.) may be metal, plastic, or ceramic.

The trays or packing may provide surface area for contact of the stripping agent 118 with the sour water 110, and thus increase contact area (and contact time). Each tray may be known as a stage for mass transfer of the hydrogen sulfide from the sour water 110 into (e.g., accepted or absorbed by) the stripping agent 118. A certain longitudinal distance of packing in the column 102 may be known as a theoretical stage for mass transfer of the hydrogen sulfide from the sour water 110 to the stripping agent 118.

Stripping is a physical separation process where one or more components (e.g., hydrogen sulfide) are removed from a liquid stream (e.g., sour water 110) by a vapor or gas stream (e.g., stripping agent 118). In industrial applications, the liquid and gas streams can have co-current or countercurrent flows. Stripping is typically carried out in a packed or trayed column (e.g., 102). Stripping may work on basis of mass transfer. A focus may be for component A (e.g., hydrogen sulfide) in the liquid phase to transfer to the vapor/gas phase. This involves a gas-liquid interface that component A should cross. The amount of component A that has moved across this boundary can be defined as the flux of component A, NA. This mass transfer may be from one phase (liquid such as sour water) to another phase (gas/vapor such as the stripping agent).

The operating pressure of the sour water stripper column 102 may be, for example, in the range of 1 pound per square inch gauge (psig) to 50 psig. The operating pressure may vary across the height of the column. The operating pressure may be generally greater at the bottom of the column 102 than at the top of the column 102. The operating temperature of the sour water stripper column 102 is generally at least ambient (e.g., 70° F. to 120° F.), and can be higher temperature, such as with live steam (or reboiled steam) injection as (or in addition to) the stripping agent 118.

The sour water stripper column 102 may have a treated water outlet 124 on the lower or bottom portion of the sour water stripper column 102 to discharge treated water 126 through a treated-water discharge conduit coupled to the treated water outlet 124. The treated water outlet 124 may be a vessel outlet nozzle to give a flanged connection, threaded (screwed) connection, or welded connection with the treated-water discharge conduit. In operation, the treated water may be discharged through the discharge conduit to downstream processing, distribution for use, or for disposal as waste, and the like. The treated water 126 can be labeled as treated sour water, the treated water outlet 124 can be labeled as a treated sour-water outlet, and the treated-water discharge conduit labeled as a treated sour-water discharge conduit.

The treated water 126 may include the sour water 110 minus (without) the hydrogen sulfide (and any additional components) removed from the sour water in the sour water stripper column 110. The treated water 126 may include less than 20 ppm by weight (ppmv) of hydrogen sulfide. In implementations, the concentration of hydrogen sulfide in the treated water 126 is less than 1 ppmw.

In the illustrated embodiment, the sour water stripper column 102 has an off-gas outlet 128 on an upper portion (top portion) of the stripper column vessel to discharge off-gas 130 through an off-gas discharge conduit to the ejector 104. The off-gas discharge conduit may be coupled to the off-gas outlet 124 and to a process inlet (off-gas inlet) of the ejector 104. The off-gas outlet 124 may be a vessel outlet nozzle to give a flanged connection, threaded (screwed) connection, or welded connection with the off-gas discharge conduit.

The off-gas 126 may be labeled, for example, as acid gas or spent stripping agent. The off-gas 126 may include the stripping agent 118 and the hydrogen sulfide (and any additional components, e.g., NH₃, carbon dioxide (CO₂), etc.) stripped (removed) from the sour water 110 via (into) the stripping agent 118 in the sour water stripper column 102. In implementations, the off-gas 126 as discharged through the off-gas outlet 124 from the sour water stripper column 110 may be characterized as an overhead stream of the sour water stripper column 102. In some implementations, a control valve may be disposed along the off-gas discharge conduit to regulate (adjust, modulate, maintain, alter) the flow rate (e.g., volume per time, mass per time, etc.) of the off-gas 130.

In implementations, a control valve 132 may be disposed along the motive-gas supply conduit to regulate (adjust, modulate, maintain, alter) the flow rate (e.g., volume per time, mass per time, etc.) of the motive gas 134. The control valve 132 may be a flow control valve in which an entered set point for the flow rate is maintained. The control valve 132 can be a pressure control valve in which an entered set point for pressure (e.g., in psig) is maintained. The pressure control valve may adjust the flow rate of the motive gas 134 to maintain the pressure of the motive gas 134 at set point. The control valve 132, whether a flow control valve maintaining flow rate of the motive gas 134 at a flow-rate set point or a pressure control valve maintaining pressure of the motive gas 134 at pressure set point, may thus facilitate control of pressure of the off-gas 130 entering the ejector 104 and/or facilitate control of flow rate and/or pressure of the discharge gas 136 from the ejector 104. In implementations, the control valve 132 may be utilized to facilitate pressure control (control of pressure) in the sour water stripper column 102. However, the pressure in the stripper column 102 may be allowed to operate close to ambient (e.g., 1 psig to 15 psig) with the weight of the sour water 110 in the column 102 (and potentially the supply pressure of the stripping agent 118 to the column 102) affecting pressure in the stripper column 102.

The term “ejector” in the disclosed context is known by one of ordinary skill in the art. The ejector 104 may also be called a jet ejector, gas ejector, jet pump, jet compressor, eductor, etc. In operation, the ejector 104 may receive motive gas 134 (at higher pressure), receive and draw in the off-gas 130 (at lower pressure), and discharge a gas stream 136 (including the motive gas 134 and the off-gas 130). The discharge pressure of the gas stream 136 may be a pressure intermediate the higher supply pressure of the motive gas 134 and the lower supply pressure of the off-gas 130. Thus, the ejector 104 increases the pressure of the off-gas 130 and therefore provides motive force for flow of the off-gas 130 to the suction of the injection compressor 106. The gas stream 136 may be labeled as pressurized gas with respect to the pressure of the incoming off-gas 130.

The ejector 104 may have at least three connections: motive, suction, and discharge. In particular, the ejector 104 has two feed inlets (motive-gas inlet and off-gas inlet) and one discharge (which may be labeled as an outlet or as the ejector outlet or the ejector discharge). The motive-gas inlet may couple (e.g., flanged, screwed, or welded connection) to the motive-gas supply conduit conveying the motive gas 134 from the source 138 of the motive gas 134. The off-gas inlet of the ejector 104 may couple (e.g., flanged, screwed, or welded connection) to the off-gas discharge conduit 130 conveying the off-gas 130 from the sour water stripper column 102. The ejector outlet may couple (e.g., flanged, screwed, or welded connection) to the ejector discharge conduit conveying the gas stream 136 to the suction (inlet) of the injection compressor 106.

The source 138 of the motive gas 134 may be an adjacent processing unit (e.g., natural gas processing plant, an acid-gas handling or treatment system, etc.) or a utility header (e.g., fuel gas sub-header). The motive gas 134 may be a slipstream of a process stream (e.g., hydrocarbon, acid gas, etc.) at adequate pressure to serve as the motive-gas 134. The motive gas 134 may be fuel gas, which is (or includes) typically natural gas, and in which the majority of the natural gas may be methane.

The ejector 104 may include a nozzle in an inlet portion (approximate initial half) and a diffuser (a diffuser section) in the outlet portion (approximate final half). The ejector 104 may function by accelerating the motive gas 134 as a higher-pressure stream through the internal nozzle, converting the pressure energy into velocity. At or near the internal volume nozzle tip, where velocity is generally highest, a low-pressure region is generated. This may be called the suction chamber of the ejector 104 and in which the off-gas 130 as suction fluid is received (drawn-in). In implementations, the pressure in this region may be lower than the supply pressure of the off-gas 130. Thus, the off-gas 130 may be sucked into the body of the ejector 104 and entrained in the motive gas 134. The two fluid streams (e.g., off-gas 130 and motive gas 134) as combined then travel through the diffuser section of the ejector, where velocity is decreased because of the diverging geometry and pressure is regained, increasing the pressure to greater than that of the supply pressure of the off-gas 130. This discharge pressure of the ejector 104 is greater than the suction pressure of the injection compressor 106. The off-gas 130 as a low pressure suction stream experiences a pressure increase/compression, whilst the motive stream sees a decrease in pressure, as some of the motive stream energy it utilized to ‘do work’ on the suction stream. The value of the resultant discharge pressure of the ejector is between the motive and suction pressures.

This discharge pressure of the ejector 104 is greater than the suction pressure of the injection compressor 106, e.g., by at least an amount to account for hydraulic losses (due to friction) in the ejector discharge conduit. Therefore, the ejector 104 provides adequate motive force for flow of the gas stream 136 through the ejector discharge conduit to the suction of the injection compressor 106. In one example, the pressure of the motive gas 134 is 300 psig, the supply pressure off-gas 130 from the sour water stripper column 120 is 3 psig, the pressure of the gas stream 136 at the ejector 104 outlet is 55 psig, and the suction pressure (pressure at the suction) of the injection compressor is 20 psig. In another example, the pressure of the motive gas is 350 psig, the supply pressure of the off-gas 130 at the discharge (outlet 128) of the sour water stripper column 120 is 5 psig, the pressure of the gas stream 136 at the ejector 104 outlet is 60 psig, and the suction pressure (pressure at the suction) of the injection compressor is 30 psig. The pressure of the motive gas 134 at the motive-gas inlet of the ejector 104 may be, for example, in the range of 50 psig to 500 psig. The pressure of the off-gas 130 at the discharge (outlet 128) of the sour water stripper column 102 may be, for example, in the range of 1 psig to 10 psig. The pressure of the gas stream 136 at the ejector 104 outlet may be, for example, in the range of 30 psig to 150 psig. The suction pressure of the injection compressor 106 may be, for example, in the range of 5 psig to 100 psig, or in the range of 10 psig to 60 psig.

The injection compressor 106 may be a mechanical compressor that is a multi-stage compressor, as would be understood by one of ordinary skill in the art. The compressor 106 is labeled as an injection compressor because the compressor 106 injects the gas stream 136 through an injection well 108 (wellbore) into a hydrocarbon reservoir 140 in a subterranean formation 142.

The injection compressor 106 may have a suction conduit and/or suction manifold. In implementations, the injection compressor 106 may compress/inject additional streams (e.g., acid gas, etc.) combined with the gas stream 106 via a suction manifold coupled to the suction inlet of the injection compressor 106. Further, the injection compressor 106 can be paired or operate with adjacent injection compressors that compress/inject fluid through the injection well 108 into the hydrocarbon reservoir 140. Further, more than one injection well 108 may be present generally at the location.

As mentioned, the injection compressor 106 may operate given a suction pressure (the pressure at the inlet to the compressor 106), for example, in the range of 5 psig to 100 psig, or in the range of 10 psig to 60 psig. The injection compressor 106 may compress (increase the pressure of) the received gas stream 106. The discharge pressure of the injection compressor 106 (the pressure of the discharged gas stream 106) may be, for example, in a range of 800 psig to 5000 psig. The gas stream 136 as pressurized by the injection compressor 106 may flow through an injection-compressor discharge conduit to the injection well 108. The injection well 108 may include a wellbore formed through the Earth surface into a subterranean formation 142 in the Earth crust. The injection (discharge) pressure provided by the injection compressor 106 may force the gas stream 136 through the wellbore into the hydrocarbon reservoir 140 in the subterranean formation 142. This injected gas stream 136 may help to maintain (including to increase or to avoid significant decrease) of the pressure of the hydrocarbon reservoir 140. Such may be referred to as pressure maintenance of the hydrocarbon reservoir 140.

A diversion valve 146 (e.g., 3-way valve) to divert off-gas 130 away from the injection compressor 106 and the injection well 108 may be disposed along the off-gas discharge conduit conveying the off-gas 130 to the ejector 104. The diversion valve 146 may instead be installed on the discharge conduit from the ejector 104 to divert the gas stream 136 away from the injection compressor 106. In either case, the diversion may be operationally implemented when desired that a user 148 other than the injection compressor 106 receive the off-gas 130.

This alternate user 148 may be, for example, a flare system, a furnace, a sulfur recovery unit (SRU), an amine treatment unit, and so on. The diversion can be in response to an abnormal operation, such as the injection compressor 106 (and any applicable sister injection compressors) shut down or placed on standby (out-of-operation). This scenario may include that no injection compressor is operationally available to receive and compress/inject the gas stream 106 from the ejector 104.

For the alternate user 148 as a flare system, the flare system may include a flare header and a flare. As appreciated by one of ordinary skill in the art, a flare may include a flare stack and a flare tip. The off-gas 130 may enter the flare header (conduit) in route to the flare. The off-gas 130 may flow from the flare header through the flare stack to the flare tip. The flare tip may ignite and combust the off-gas 130 for disposal.

The diversion valve 146 can be an automated valve as depicted (and operated, for example, via a local control panel or a control system 150), or can be a manual valve operated manually (directly) by a human in the field to set the position of the valve 146. The normal operating position of the diversion valve 146 may be such that the off-gas 130 flows from the sour water stripper column 102 through the valve 146 to the ejector 104. The abnormal (not normal) operating position of the diversion valve 146 may be to route (divert) the off-gas 130 from the sour water stripper column 102 through the valve 146 to the alternate user 148, as indicated by arrow 152. In this not normal operating position, the off-gas 130 may flow through an alternate conduit from the valve 146 to the alternate user 148. For the valve 146 as a control valve, the valve 146 can be configured to fail (1) to the valve position for normal operation or (2) to the valve position for diversion (not normal operation), depending on plant (facility) considerations with respect, for example, to the alternate user 148 and the injection compressor 106. (In implementations, the diversion valve 146 may also additionally be configured as a flow control valve (or pressure control valve) to regulate flow rate of the off-gas 130 to the ejector 104.)

In implementations, the system 100 may further include an isolation valve 154 disposed along the ejector 104 discharge conduit. The isolation valve 154 may be a manual valve as depicted, or can be an automated valve. In some implementations, the isolation valve 154 may be an on/off valve (e.g., a full port valve) or operated as an on/off valve. The normal operating position of the isolation valve 154 may be “on” in that the valve 154 is fully open (e.g., for a full port valve providing little hydraulic resistance to flow) with the gas stream 136 flowing to the injection compressor 106 as normal. The abnormal (not normal) operating position of the isolation valve 154 may be “off” in that the valve 154 is in a closed position (e.g., fully closed position). Therefore, in this fully closed position, the ejector 104 (and thus the sour water stripper system 100 generally) may be isolated from the injection compressor 104, such that there is little or no flow between the ejector 104 and the injection compressor 106.

This isolation may be desirable, for example, when the diversion valve 146 is diverting off-gas 130 to the alternate user 148. Moreover, in such a diversion, the motive gas 134 may be turned off (closed and isolated from the ejector 104). Lastly, the diversion valve 136 may instead be installed on the ejector discharge conduit (conveying the gas stream 136 to the injection compressor) to divert the gas stream 136 (or any fluid flow through the ejector discharge conduit) away from the injection compressor 106 and the injection well 108.

In some embodiments, the sour water stripper column 102 may have (include or be associated with) steam supply 154, which is represented as a dashed box in FIG. 1 because the steam supply 154 may be an alternate configuration for the system 100. The steam supply 154 can be a steam-supply conduit to supply live steam injection to the sour water stripper column 102. This live steam injection can be in addition to the depicted stripping agent 118 supply. The steam supply 154 can be a steam reboiler heated by provided steam and that evaporates a portion of the treated water 126, and supplies steam to the sour water stripper column 102 for upward flow of the steam in the sour water stripper column 102.

In some embodiments, the sour water stripper column 102 may have (include or be associated with) an overhead system 156, which is represented as a dashed box in FIG. 1 because the overhead system 156 may be an alternate configuration for the system 100. The overhead system 156 can include (have) an overhead condenser (heat exchanger, such as a shell-and-tube heat exchanger) that is a partial condenser. The condenser may condense a portion of the off-gas 130. In implementations, the overhead system 156 can include a conduit (e.g., reflux conduit) that conveys at least some of the condensed off-gas 130 as return (e.g., reflux) to the sour water stripper column 102, e.g., to an upper portion of the sour water stripper column 102. The overhead system 156 can include a reflux system including an accumulator vessel or reflux pump, or both, for return (as reflux) of at least a portion of the condensed off-gas 130 to an upper portion (e.g., along the straight side) of the sour water stripper column 102.

The sour water stripper system 100 can include two sour water stripper columns operationally in series, one (e.g., the first) being configured to strip hydrogen sulfide and the other (e.g., the second) being configured to strip ammonia. The sour water stripper column directed to stripping (removing) hydrogen sulfide from the sour water 110 can discharge the off-gas 130 to the ejector 104, as depicted in FIG. 1. The treated water 126 can be fed to the second stripper column direct to stripping (removing) ammonia from the treated water 126. In such a configuration, the acid 116 may be added to give the sour water 110′ as acidified for feed to the first stripper column configured to remove hydrogen sulfide, and a base (e.g., caustics or sodium hydroxide) added to the treated water 126 (increasing pH) for efficient NH₃ removal in the second sour water stripper column. The acidified sour water 110′, while considered sour water herein, can be labeled as raw water.

The sour water stripper system 100 may include the control system 150 that facilitates processes of the stripper system 100 including to support or direct operations and equipment of the stripper system 100. For example, the set point for the control valve 132 may entered by a human user via the control system 150, or the control system 150 may otherwise calculate or determine the set point of the control valve 132, such as based on entered constraints and operational feedback from sensors in the stripper system 100. The control system 150 may automatically decide when to alter the operating position of the control valve 146, such as based on feedback received from injection system having the injection compressor 106. A human operator may alter the operating position of the control valve 146 via the control system 150.

The control system 150 includes a processor and memory storing code (logic, instructions) executed by the processor to perform calculations and direct operations of the stripper system 100. The processor may be one or more processors and each processor may have one or more cores. These hardware processor(s) may include a microprocessor, a central processing unit (CPU), a graphic processing unit (GPU), a controller card, or other circuitry. The memory may include volatile memory (for example, cache and random access memory (RAM)), nonvolatile memory (for example, hard drive, solid-state drive, and read-only memory (ROM)), and firmware. The control system 150 may include a desktop computer, laptop computer, computer server, programmable logic controller (PLC), distributed computing system (DSC), controllers, actuators, control cards, an instrument or analyzer, and a user interface.

The control system 150 may be disposed remotely in a control room, and/or disposed in the field such as with control modules and apparatuses distributed in the field. The control system 150 may be communicatively coupled to a remote computing system that performs calculations and provides direction. The control system 150 may receive user input or remote-computer input that specifies the set points of control devices or other control components in the sour water stripper system 100.

Determinations by the control system 150 may be based at least in part on values of operating conditions of the sour water stripper system 100 received via feedback from (e.g., from sensors in) the sour water stripper system 100.

Some implementations may include a control room that can be a center of activity, facilitating monitoring and control of the process or facility. The control room may contain a human machine interface (HMI), which is a computer, for example, that runs specialized software to provide a user-interface for the control system. The HMI may vary by vendor and present the user with a graphical version of the remote process. There may be multiple HMI consoles or workstations, with varying degrees of access to data. The control system 150 may also or instead employ local control (e.g., distributed controllers, local control panels, etc.) distributed in the system 100.

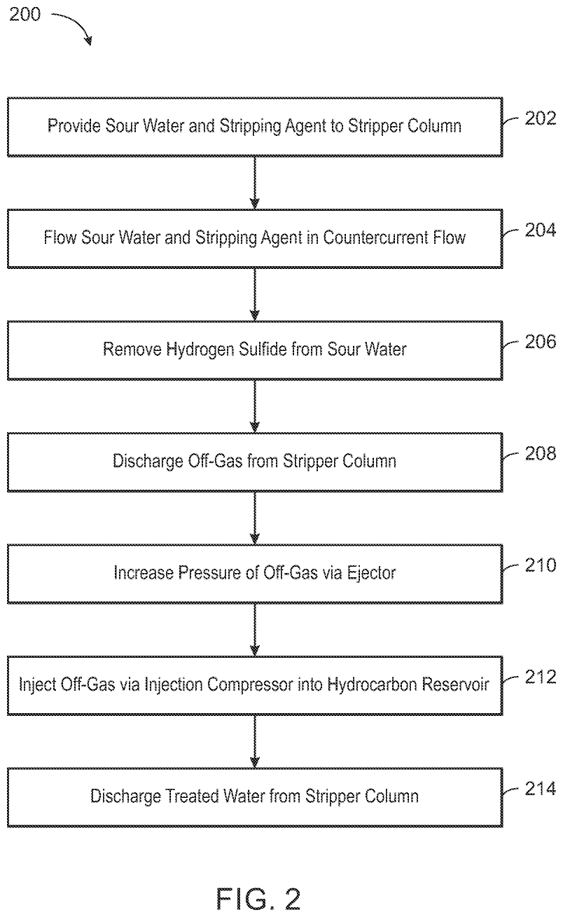

FIG. 2 is a method 200 of treating sour water, such as with a sour water stripper system (e.g., system 100 of FIG. 1). In implementations, the sour water includes at least 20 ppmw of hydrogen sulfide (e.g., in the range of 20 ppmw to 2000 ppmw). The sour water stripper system include a sour water stripper column and an ejector.

At block 202, the method includes providing the sour water to the sour water stripper column. For example, the sour water may be fed to (and introduced into) an upper portion of the sour water stripper column. Further, the method includes providing a stripping agent (e.g., nitrogen gas) to the sour water stripper column. For example, the stripping agent may fed to (and introduced into) a lower portion of the sour water stripper column.

At block 204, the method includes flowing the sour water and the stripping agent in a countercurrent flow with respect to each other in the sour water stripper column. The countercurrent flow may involve flowing the sour water downward in the sour water stripper column and flowing the stripping agent upward in the sour water stripper column. For instance, the sour water may be fed (block 202) to the upper portion of the sour water stripper column, so that the method includes flowing the sour water downward in the sour water stripper column. The stripping agent may be fed (block 202) to a lower portion of the sour water stripper column, so that the method includes flowing the stripping agent upward in the sour water stripper column in the countercurrent flow direction with respect to the sour water flowing downward.

At block 206, the method includes removing (stripping) hydrogen sulfide from the sour water in the sour water stripper column via the stripping agent to give treated water (treated sour water) and off-gas. The removing of the hydrogen sulfide involves transfer (e.g., mass transfer) of hydrogen sulfide from the sour water to the stripping agent. The sour water stripper column may include internals, such as trays or packing, or both, to promote (facilitate) the transfer (e.g., mass transfer) of the hydrogen sulfide from the sour water to the stripping agent.

At block 208, the method includes discharging off-gas from the sour water stripper column through an ejector to an injection compressor. In particular, the method may include discharging the off-gas overhead (e.g., as an overhead stream) from the upper portion of the sour water stripper column to the ejector that provides motive force for flow of the off-gas to the injection compressor. The off-gas includes the stripping agent and the hydrogen sulfide removed (stripped) from the sour water. The off-gas includes, for example, at least 1000 ppmw of hydrogen sulfide.

At block 210, the method (in accordance with block 208) includes increasing pressure of the off-gas via the ejector. The pressure of the off-gas may be increased via the ejector to a pressure greater than suction pressure of the injection compressor. The method may include providing motive gas (e.g., fuel gas, methane, fuel gas including methane, etc.) to the ejector to provide for motive force and increase in pressure of the off-gas.

At block 212, the method includes injecting the off-gas via the injection compressor into a hydrocarbon reservoir in a subterranean formation. To provide the off-gas to the injection compressor, the method may include discharging a gas stream having the off-gas and the motive gas from the ejector to the injection compressor. Thus, the injecting of the off-gas may involve injecting, via the injection compressor, the gas stream into the hydrocarbon reservoir. The injecting of the off-gas (or gas stream having the off-gas) may facilitate pressure maintenance (maintaining pressure) in the hydrocarbon reservoir. In examples, the hydrocarbon in the hydrocarbon reservoir includes crude oil.

In some implementations, the method may include diverting the off-gas to a flare (instead of to the injection compressor) in response to the injection compressor shutting down (e.g., an unplanned or planned shutdown). For instance, the injection compressor may experience a machine trip in which electricity supply to the compressor is stopped. In the operation of diverting the off-gas to the flare instead of flowing the off-gas to the injection compressor, which may generally be an abnormal operation, the off-gas may be combusted via the flare.

At block 214, the method includes discharging the treated water from the sour water stripper column, wherein the treated water includes the sour water minus the hydrogen sulfide (and any other components) removed (stripped) from the sour water in the sour water stripper column. The method may include discharging the treated water as a bottoms stream from a bottom portion of the sour water stripper column. The treated water can be labeled as treated sour water, but typically may have less than 1 ppmw of hydrogen sulfide.

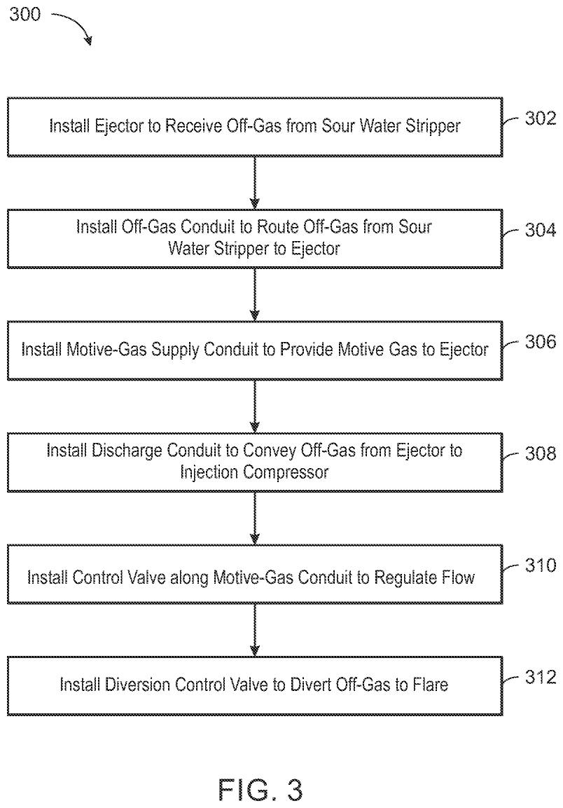

FIG. 3 is a method 300 of retrofitting a sour water stripper system that flares off-gas (e.g., 130 of FIG. 1). The off-gas may enter the flare header (conduit) in route to the flare. The off-gas may flow from the flare header through the flare stack of the flare to the flare tip of the flare. The flare tip may ignite and combust the off-gas for disposal. The off-gas may discharge from a sour water stripper column of the sour water stripper system. The off-gas may include stripping agent (e.g., nitrogen gas) and hydrogen sulfide removed from sour water.

This existing sour water stripper system is generally not configured for an alternate disposition of the off-gas except, for example, possibly to discharge the off-gas to the environment in an abnormal operation. The existing sour water stripper system is not configured to provide the off-gas to an injection compressor.

The retrofit reconfigures this sour water stripper system to route the off-gas (as normal operation) to the suction of an injection compressor (e.g., 106 of FIG. 1) instead of to the flare. The retrofit reroutes the off-gas to the injection compressor for injection into a hydrocarbon reservoir via an injection well. Therefore, beneficially, the retrofitted system may avoid contributing to undesirable flare emissions (e.g., sulfur dioxide from the combustion of the hydrogen sulfide in the off-gas in the flare). Yet, the retrofit may retain or otherwise include capability to route the off-gas to the flare, such as for operational instances (which may be rare) in which the injection compressor is shutdown or otherwise operationally unavailable.

In implementations, the sour water stripper column is not associated with (having or including) a reboiler, not associated with (having or including) an overhead condenser, and/or not associated with (having or including) a reflux system.

At block 302, the method (method of retrofit) includes installing an ejector to receive off-gas from a sour water stripper column of the sour water stripper system. The sour water stripper column is configured to flow sour water and a stripping agent in a countercurrent flow to remove hydrogen sulfide from the sour water to give treated water and the off-gas. The treated water includes the sour water minus the hydrogen sulfide removed from the sour water. The off-gas includes the stripping agent and the hydrogen sulfide removed from the sour water. The off-gas may have at least 1000 ppmw of hydrogen sulfide. The sour water stripper column may have internals including trays or packing, or both, to promote removing (stripping) of the hydrogen sulfide from the sour water.

At block 304, the method includes installing an off-gas discharge conduit to route the off-gas discharged overhead from an upper portion of the sour water stripper column to the ejector. Installing the off-gas discharge conduit may involve coupling the off-gas discharge conduit to an off-gas inlet of the ejector. Installing the off-gas discharge conduit may involve coupling the off-gas discharge conduit to an off-gas outlet of the sour water stripper column and to a process inlet (off-gas inlet) of the ejector, wherein the sour water stripper column includes a stripper column vessel having the off-gas outlet on the upper portion to discharge the off-gas overhead.

At block 306, the method includes installing a motive-gas supply conduit to provide motive gas to the ejector. In implementations, the motive gas may be, for example, fuel gas including methane. To provide the motive gas, the motive-gas supply conduit may be configured to convey (transport) the motive gas to a motive-gas inlet of the ejector. Installing the motive-gas supply conduit may involve coupling the motive-gas supply conduit to the motive-gas inlet of the ejector.

At block 308, the method includes installing an ejector discharge conduit to convey (transport) a gas stream having the off-gas and motive gas discharged from the ejector (ejector outlet) to an injection compressor (e.g., to the suction of the injection compressor). The ejector may be configured to discharge the off-gas via or with aid of the motive gas to the injection compressor for injection of the off-gas into the hydrocarbon reservoir. The injection compressor is configured to inject the gas stream via an injection well into a hydrocarbon reservoir in a subterranean formation.

The installing of the ejector discharge conduit may involve coupling the ejector discharge conduit to an ejector outlet of the ejector. In particular, installing the ejector discharge conduit may involve coupling the ejector discharge conduit to the ejector outlet of the ejector that discharges the gas stream including the off-gas and the motive gas from the ejector through the ejector discharge conduit to a suction of the injection compressor. Thus, in view of blocks 302-308, the ejector may be configured to provide motive force for flow of the off-gas to the injection compressor for injection of the off-gas by the injection compressor into the hydrocarbon reservoir.

At block 310, the method includes installing a control valve (e.g., 132 of FIG. 1) along the motive-gas supply conduit to regulate (modulate, alter, adjust, maintain, etc.) flow rate of the motive gas to the ejector. The flow rate regulated may be, for example, a volumetric flow rate or a mass flow rate. The control valve can be a flow control valve as having operating with an entered set point for flow rate.

The control valve can be a pressure control valve operating with an entered set point for pressure, and in which the control valve regulates flow rate to maintain pressure at set point. The pressure of the motive gas (e.g., in the motive-gas supply conduit) can be measured via a pressure sensor and indicated via an instrument (pressure) transmitter to a control system (e.g., 150 of FIG. 1). The measured pressure value input for the control may be pressure locally in the conduit downstream or upstream of the control valve.

At block 312, the method includes installing a control valve (a diversion control valve) along the off-gas discharge conduit or along the ejector discharge conduit to divert the off-gas to a flare system in response to a shutdown of the injection compressor. This control valve (e.g., 146 of FIG. 1) may be, for example, a 3-way valve and automated. The method can include installing a conduit (and/or relying on an existing conduit) to route the off-gas to the flare from the diversion control valve.

Embodiments may be [1] a retrofit of an existing sour water stripper system (e.g., that flares off-gas) and/or [2] a grassroots (green) construction in which there is no existing sour water stripper—and the initial installation of the newly-installed sour water stripper includes to route the off-gas to an injection compressor.

An embodiment is method of treating sour water, including flowing sour water and a stripping agent in a countercurrent flow with respect to each other in a sour water stripper column, and removing hydrogen sulfide from the sour water in the sour water stripper column to give treated water, wherein removing involves transfer (e.g., mass transfer) of hydrogen sulfide from the sour water to the stripping agent. The stripping agent may be or include nitrogen (N₂) gas. The sour water as received may have at least 20 ppm by weight of hydrogen sulfide. The sour water stripper column may have trays or packing, or both, to promote the transfer of the hydrogen sulfide from the sour water to the stripping agent. The method may include providing the sour water to an upper portion of the sour water stripper column, wherein the countercurrent flow involves flowing the sour water downward in the sour water stripper column. The method may include providing the stripping agent to a lower portion of the sour water stripper column, wherein the countercurrent flow involves flowing the stripping agent upward in the sour water stripper column.

The method includes discharging off-gas from the sour water stripper column (e.g., as an overhead stream from an upper portion of the sour water stripper column) through an ejector to an injection compressor, the off-gas including the stripping agent and the hydrogen sulfide removed from the sour water. The off-gas may have at least 1000 ppm by weight of hydrogen sulfide. The method includes increasing, via the ejector, pressure of the off-gas, such as to a pressure greater than suction pressure of the injection compressor. The method includes injecting, via the injection compressor, the off-gas into a hydrocarbon reservoir in a subterranean formation. The injecting of the off-gas may facilitate pressure maintenance in the hydrocarbon reservoir. The hydrocarbon in the hydrocarbon reservoir may include crude oil. The method may include diverting the off-gas to a flare (instead of to the injection compressor) in response to the injection compressor shutting down. The method may include providing a motive gas (e.g., methane) to the ejector, and discharging a gas stream including the motive gas and the off-gas from the ejector to the injection compressor, wherein injecting the off-gas involves injecting, via the injection compressor, the gas stream into the hydrocarbon reservoir.

The method may include discharging the treated water from the sour water stripper column (e.g., as a bottoms stream from a bottom portion of the sour water stripper column), wherein the treated water includes the sour water minus the hydrogen sulfide removed from the sour water in the sour water stripper column. In implementations, the sour water stripper column is not associated with an overhead condenser heat exchanger. In implementations, the sour water stripper column is not associated with a reboiler heat exchanger.

Another embodiment is a method of treating sour water, including feeding sour water (e.g., having at least 20 ppm by weight of H₂S) to an upper portion of a sour water stripper column and flowing the sour water downward in the sour water stripper column, feeding a stripping agent (e.g., nitrogen gas) to a lower portion of the sour water stripper column and flowing the stripping agent upward in the sour water stripper column in a countercurrent flow direction with respect to the sour water, and stripping hydrogen sulfide from the sour water via the stripping agent to give treated water. The sour water stripper column may have trays or packing, or both, to promote stripping of the hydrogen sulfide from the sour water. The stripping of the hydrogen sulfide from the sour water may involve mass transfer of the hydrogen sulfide from the sour water to the stripping agent. The method includes discharging off-gas overhead from the upper portion of the sour water stripper column to an ejector that provides motive force for flow of the off-gas to an injection compressor. The off-gas includes the stripping agent and the hydrogen sulfide stripped from the sour water. The method includes providing motive gas (e.g., fuel gas) to the ejector. The method includes discharging the treated water from the lower portion of the sour water stripper column. The treated water includes the sour water minus the hydrogen sulfide and other components stripped from the sour water. The method may include injecting, via the injection compressor, the off-gas into a hydrocarbon reservoir in a subterranean formation. The injecting of the off-gas into the hydrocarbon reservoir may facilitate maintaining pressure in the hydrocarbon reservoir. The hydrocarbon in the hydrocarbon reservoir may include crude oil. The method may include diverting the off-gas to a flare instead of flowing the off-gas to the injection compressor, and combusting the off-gas via the flare. In implementations, the sour water stripper column does not include (nor is associated with) a reflux system. In implementations, the sour water stripper column does not include a steam reboiler.

Yet another embodiment is a sour water stripper system including a sour water stripper column that is a stripper column vessel to receive sour water e.g., having at least 20 ppmw of H₂S) and a stripping agent (e.g., N₂) to strip hydrogen sulfide from the sour water via the stripping agent in a countercurrent flow of the sour water with the stripping agent to give treated water and off-gas. The treated water may include the sour water minus hydrogen sulfide stripped from the sour water. The off-gas may include the stripping agent and the hydrogen sulfide stripped from the sour water. The sour water stripper column may have internals including trays or packing, or both, to promote stripping of the hydrogen sulfide from the sour water. The sour water stripper system includes an ejector to receive the off-gas discharged from the stripper column vessel and discharge the off-gas via a motive gas to an injection compressor for injection of the off-gas into a hydrocarbon reservoir. The sour water stripper system includes an off-gas discharge conduit to convey the off-gas from the stripper column vessel to the ejector. The sour water stripper system includes an ejector discharge conduit to convey the off-gas and the motive gas from the ejector to a suction of the injection compressor.

The sour water stripper system may include a sour-water feed conduit to convey the sour water from a source to a sour-water feed inlet on an upper portion of the stripper column vessel for flow of the sour water downward in the stripper column vessel. The sour water stripper system may include a stripping-agent feed conduit to convey the stripping agent to a stripping-agent feed inlet on a lower portion of the stripper column vessel for flow of the stripping agent upward in the stripper column vessel. The stripper column vessel may have an off-gas outlet on an upper portion of the stripper column vessel to discharge the off-gas through the off-gas discharge conduit to the ejector, wherein the off-gas discharge conduit is coupled to the off-gas outlet and to a process inlet of the ejector. The sour water stripper system may have a motive-gas supply conduit to convey the motive gas to the ejector, wherein the ejector has a motive-gas inlet to receive the motive gas, and wherein the ejector has an ejector outlet to discharge the off-gas and the motive gas through the ejector discharge conduit to the suction of the injection compressor. The sour water stripper system may include a valve to divert the off-gas to a flare system having a flare for combustion of the off-gas via the flare, the valve disposed along the off-gas discharge conduit or the ejector discharge conduit, the valve being a manual valve or a control valve. In implementations, the sour water stripper column does not have (nor is associated with) a reboiler. In implementations, the sour water stripper column does not have (nor is associated with) an overhead condenser.

Yet another embodiment is a sour water stripper system including a sour water stripper column that is a stripper column vessel having internals to strip hydrogen sulfide from sour water (e.g., having at least 20 ppmw of H₂S) via a stripping agent (e.g., N₂) in a countercurrent flow of the sour water with the stripping agent to give treated sour water and off-gas. The treated sour water includes the sour water minus the hydrogen sulfide stripped from the sour water. The off-gas (e.g., having at least 1000 ppmw H₂S) includes the stripping agent and the hydrogen sulfide stripped from the sour water. The sour water stripper system includes a sour-water feed conduit to convey the sour water from a source to a sour-water feed inlet on an upper portion of the stripper column vessel for flow of the sour water downward in the stripper column vessel. The sour water stripper system includes a stripping-agent feed conduit to convey the stripping agent to a stripping-agent feed inlet on a lower portion of the stripper column vessel for flow of the stripping agent upward in the stripper column vessel.

The sour water stripper system includes an ejector to provide motive force for flow of the off-gas to an injection compressor for injection of the off-gas by the injection compressor into a hydrocarbon reservoir. The ejector is configured to receive the off-gas discharged from the stripper column vessel through an off-gas outlet on a top portion of the stripper column vessel. An off-gas discharge conduit is coupled to the off-gas outlet to convey the off-gas to a process inlet of the ejector. The ejector may include a motive-gas inlet to receive motive gas (e.g., fuel gas including methane) to provide the motive force for the flow of the off-gas to the injection compressor. The sour water stripper system may include an ejector discharge conduit to convey the off-gas from an outlet of the ejector. The ejector may include the outlet to discharge a gas stream including the off-gas and the motive gas (via the ejector discharge conduit) to the injection compressor. A control valve may be disposed along the off-gas discharge conduit or the ejector discharge conduit to divert the off-gas to a flare system in response to lack of operation of the injection compressor. The stripper column vessel may have a treated sour-water outlet on a bottom portion of the stripper column vessel to discharge the treated sour water (e.g., having less than 20 ppmw H₂S) from the stripper column vessel through a sour-water discharge conduit. In implementations, the sour water stripper column is not associated with a reboiler, the sour water stripper column is not associated with an overhead condenser, and the sour water stripper column is not associated with a reflux system.

### Example

A simulation was performed utilizing ProMax® (version 5.0) process simulation software available from Bryan Research & Engineering, LLC having headquarters in Bryan, Texas, USA. The simulation data is shown in Table 1 below. The associated reference numerals from FIG. 1 are given for each of the six streams in Table 1. The flow rate for the streams is either: [1] liquid volumetric flow in gallons per minute (GPM); or [2] standard vapor volumetric flow in million standard cubic feet per day (MMSCFD). The stripping agent 118 in the simulation was nitrogen gas. The motive gas 134 was fuel gas (natural gas).

TABLE 1
Simulation Data

| | Sour Water | | Stripping Agent | | Treated Water | | Off-Gas | | Motive Gas | | Gas Stream | |
|---|---|---|---|---|---|---|---|---|---|---|---|---|
| | 110′ | | 118 | | 126 | | 130 | | 134 | | 136 | |
| Pressure | 102 | psig | 85 | psig | 17.7 | psig | 1 | psig | 370 | psig | 60 | psig |
| Temperature | 95° | F. | 95° | F. | 95° | F. | 95° | F. | 118° | F. | 102.7° | F. |
| Flowrate | 271.5 | GPM | 0.4 | MMSCFD | 271.3 | GPM | 0.436 | MMSCFD | 4.13 | MMSCFD | 4.57 | MMSCFD |

| | | | | | | |
|---|---|---|---|---|---|---|
| H₂S Content | 200 | 0 | 0 | 31330 | 0 | 0 |
| (ppmw) | | | | | | |

A number of implementations have been described. Nevertheless, it will be understood that various modifications may be made without departing from the spirit and scope of the disclosure.

What is claimed is:

1. A method of treating sour water, comprising:
flowing sour water and a stripping agent in a countercurrent flow with respect to each other in a sour water stripper column;
removing hydrogen sulfide from the sour water in the sour water stripper column to give treated water, wherein removing comprises transfer of hydrogen sulfide from the sour water to the stripping agent;
discharging off-gas from the sour water stripper column through an ejector to an injection compressor, the off-gas comprising the stripping agent and the hydrogen sulfide removed from the sour water;
increasing, via the ejector, pressure of the off-gas; and
injecting, via the injection compressor, the off-gas into a hydrocarbon reservoir in a subterranean formation.

2. The method of claim 1, wherein the stripping agent comprise nitrogen (N₂) gas, wherein the sour water comprises at least 20 parts per million (ppm) by weight of hydrogen sulfide, and wherein the sour water stripper column comprises trays or packing, or both, to promote the transfer of the hydrogen sulfide from the sour water to the stripping agent.

3. The method of claim 1, comprising:
discharging the treated water from the sour water stripper column, wherein the treated water comprises the sour water minus the hydrogen sulfide removed from the sour water in the sour water stripper column;
providing a motive gas to the ejector; and
discharging a gas stream comprising the motive gas and the off-gas from the ejector to the injection compressor, wherein injecting the off-gas comprises injecting, via the injection compressor, the gas stream into the hydrocarbon reservoir.

4. The method of claim 3, wherein the motive gas comprises methane, wherein the off-gas comprises at least 1000 ppm by weight of hydrogen sulfide, and wherein the sour water stripper column is not associated with an overhead condenser heat exchanger.

5. The method of claim 1, comprising:
providing the sour water to an upper portion of the sour water stripper column, wherein the countercurrent flow comprises flowing the sour water downward in the sour water stripper column; and
providing the stripping agent to a lower portion of the sour water stripper column, wherein the countercurrent flow comprises flowing the stripping agent upward in the sour water stripper column, and wherein the transfer comprises mass transfer of the hydrogen sulfide from the sour water to the stripping agent.

6. The method of claim 1, comprising discharging the treated water as a bottoms stream from a bottom portion of the sour water stripper column, wherein discharging the off-gas comprises discharging the off-gas as an overhead stream from an upper portion of the sour water stripper column, and wherein increasing pressure of the off-gas comprises increasing, via the ejector, pressure of the off-gas to greater than suction pressure of the injection compressor.

7. The method of claim 1, wherein the sour water stripper column is not associated with a reboiler heat exchanger, wherein injecting the off-gas facilitates pressure maintenance in the hydrocarbon reservoir, and wherein hydrocarbon in the hydrocarbon reservoir comprises crude oil.

8. The method of claim 1, comprising diverting the off-gas to a flare instead of the injection compressor in response to the injection compressor shutting down.

9. A method of treating sour water, comprising:
feeding sour water to an upper portion of a sour water stripper column and flowing the sour water downward in the sour water stripper column;
feeding a stripping agent to a lower portion of the sour water stripper column and flowing the stripping agent upward in the sour water stripper column in a countercurrent flow direction with respect to the sour water;
stripping hydrogen sulfide from the sour water via the stripping agent to give treated water;
discharging off-gas overhead from the upper portion of the sour water stripper column to an ejector that provides motive force for flow of the off-gas to an injection compressor, wherein the off-gas comprises the stripping agent and the hydrogen sulfide stripped from the sour water;
providing motive gas to the ejector; and
injecting, via the injection compressor, the off-gas into a hydrocarbon reservoir in a subterranean formation.

10. The method of claim 9, wherein the stripping agent comprise nitrogen (N₂) gas, wherein the sour water comprises at least 20 parts per million (ppm) by weight of hydrogen sulfide, wherein the sour water stripper column comprises trays or packing, or both, to promote stripping of the hydrogen sulfide from the sour water, and wherein stripping hydrogen sulfide from the sour water comprises mass transfer of the hydrogen sulfide from the sour water to the stripping agent.

11. The method of claim 9, comprising discharging the treated water from the lower portion of the sour water stripper column, wherein the treated water comprises the sour water minus the hydrogen sulfide and other components stripped from the sour water, wherein injecting the off-gas into the hydrocarbon reservoir facilitates maintaining pressure in the hydrocarbon reservoir, and wherein hydrocarbon in the hydrocarbon reservoir comprises crude oil.

12. The method of claim 9, wherein the motive gas comprises fuel gas, and wherein the sour water stripper column does not include a reflux system.

13. The method of claim 9, comprising:
diverting the off-gas to a flare instead of flowing the off-gas to the injection compressor; and
combusting the off-gas via the flare, wherein the sour water stripper column does not include a steam reboiler.

14. A sour water stripper system comprising:
a sour water stripper column comprising a stripper column vessel to receive sour water and a stripping agent to strip hydrogen sulfide from the sour water via the stripping agent in a countercurrent flow of the sour water with the stripping agent to give treated water and off-gas;
an ejector to receive the off-gas discharged from the stripper column vessel and discharge the off-gas via a motive gas to an injection compressor for injection of the off-gas into a hydrocarbon reservoir;
an off-gas discharge conduit to convey the off-gas from the stripper column vessel to the ejector; and
an ejector discharge conduit to convey the off-gas and the motive gas from the ejector to a suction of the injection compressor.

15. The system of claim 14, comprising:
a sour-water feed conduit to convey the sour water from a source to a sour-water feed inlet on an upper portion of the stripper column vessel for flow of the sour water downward in the stripper column vessel; and
a stripping-agent feed conduit to convey the stripping agent to a stripping-agent feed inlet on a lower portion of the stripper column vessel for flow of the stripping agent upward in the stripper column vessel.

16. The system of claim 14, wherein the stripper column vessel comprises an off-gas outlet on an upper portion of the stripper column vessel to discharge the off-gas through the off-gas discharge conduit to the ejector, and wherein the off-gas discharge conduit is coupled to the off-gas outlet and to a process inlet of the ejector.

17. The system of claim 16, comprising a motive-gas supply conduit to convey the motive gas to the ejector, wherein the ejector comprises a motive-gas inlet to receive the motive gas, wherein the ejector comprises an ejector outlet to discharge the off-gas and the motive gas through the ejector discharge conduit to the suction of the injection compressor.

18. The system of claim 14, wherein the treated water comprises the sour water minus hydrogen sulfide stripped from the sour water, wherein the off-gas comprises the stripping agent and the hydrogen sulfide stripped from the sour water, wherein the sour water stripper column does not have a reboiler, and wherein the sour water stripper column does not have an overhead condenser.

19. The system of claim 14, wherein the stripping agent comprise nitrogen (N₂) gas, wherein the sour water comprises at least 20 parts per million (ppm) by weight of hydrogen sulfide, and wherein the sour water stripper column comprises internals comprising trays or packing, or both, to promote stripping of the hydrogen sulfide from the sour water.

20. The system of claim 14, comprising a valve to divert the off-gas to a flare system comprising a flare for combustion of the off-gas via the flare, the valve disposed along the off-gas discharge conduit or the ejector discharge conduit, the valve comprising a manual valve or a control valve.

21. A sour water stripper system comprising:
a sour water stripper column comprising a stripper column vessel comprising internals to strip hydrogen sulfide from sour water via a stripping agent in a countercurrent flow of the sour water with the stripping agent to give treated sour water and off-gas, wherein the treated sour water comprises the sour water minus the hydrogen sulfide stripped from the sour water, and wherein the off-gas comprises the stripping agent and the hydrogen sulfide stripped from the sour water;
a sour-water feed conduit to convey the sour water from a source to a sour-water feed inlet on an upper portion of the stripper column vessel for flow of the sour water downward in the stripper column vessel;
a stripping-agent feed conduit to convey the stripping agent to a stripping-agent feed inlet on a lower portion of the stripper column vessel for flow of the stripping agent upward in the stripper column vessel; and
an ejector to provide motive force for flow of the off-gas to an injection compressor for injection of the off-gas by the injection compressor into a hydrocarbon reservoir, wherein the ejector is configured to receive the off-gas discharged from the stripper column vessel through an off-gas outlet on a top portion of the stripper column vessel.

22. The system of claim 21, comprising an off-gas discharge conduit coupled to the off-gas outlet to convey the off-gas to a process inlet of the ejector, wherein the sour water comprises at least 20 parts per million (ppm) by weight of hydrogen sulfide, and wherein the off-gas comprises at least 1000 ppm by weight of hydrogen sulfide.

23. The system of claim 22, comprising:
an ejector discharge conduit to convey the off-gas from an outlet of the ejector; and
a control valve disposed along the off-gas discharge conduit or the ejector discharge conduit to divert the off-gas to a flare system in response to lack of operation of the injection compressor.

24. The system of claim 21, wherein the ejector comprises:
a motive-gas inlet to receive motive gas to provide the motive force for the flow of the off-gas to the injection compressor, wherein the motive gas comprises fuel gas comprising methane; and
an outlet to discharge a gas stream comprising the off-gas and the motive gas to the injection compressor.

25. The system of claim 21, wherein the stripper column vessel comprise a treated sour-water outlet on a bottom portion of the stripper column vessel to discharge the treated sour water from the stripper column vessel through a sour-water discharge conduit, wherein the treated sour water comprises less than 20 ppm by weight of hydrogen sulfide, and wherein the stripping agent comprise nitrogen (N₂) gas.

26. The system of claim 21, wherein the sour water stripper column is not associated with a reboiler, wherein the sour water stripper column is not associated with an overhead condenser, and wherein the sour water stripper column is not associated with a reflux system.
